(19) United States
(12) Patent Application Publication
(10) Pub. No.: US 2014/0061229 A1
(43) Pub. Date: Mar. 6, 2014

(54) VENDING MACHINE WITH LOADING MEMBER

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); CHUNG CHAI, New Taipei (TW); DA-LONG SUN, Wuhan (CN); SHENG-HE LI, Wuhan (CN); WEI-YONG MA, Wuhan (CN)

(21) Appl. No.: 13/914,309

(22) Filed: Jun. 10, 2013

(30) Foreign Application Priority Data
Aug. 31, 2012 (CN) 2012103178882

(51) Int. Cl. G07F 11/42

(52) U.S. Cl. CPC G07F 11/42
USPC 221/277

(57) ABSTRACT

A vending machine has a base, a helical pushing member secured to the first side panel, and a loading member. The loading member is installed within the coils of the helical pushing member and includes a strip on which goods are supported. A positioning tab and a resilient securing structure extend from the loading member. The resilient securing structure includes an engaging portion which engages in a lower opening. A handle portion is operable to disengage the engaging tab from the lower opening enabling easy and fast mounting and dismounting of the loading member of the vending machine.

### BACKGROUND

1. Technical Field

The present disclosure relates to a vending machine with a loading member.

2. Description of Related Art

In a vending machine, some goods need to be placed to a loading member mounted in a channel to be easily moved out of the vending machine when the goods are bought by consumers. Some goods do not need a loading member. The loading member needs to be easily mounted in the channel. However, a conventional loading member is secured in the channel by a plurality of screws, which is waste of time.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a vending machine in accordance with one embodiment of the present disclosure.

FIG. 2 is an isometric view of a loading member of FIG. 1.

FIG. 3 is an assembled view of the vending machine of FIG. 1.

FIG. 4 is a cross-sectional view of the vending machine of FIG. 3 taken along a line IV-IV.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

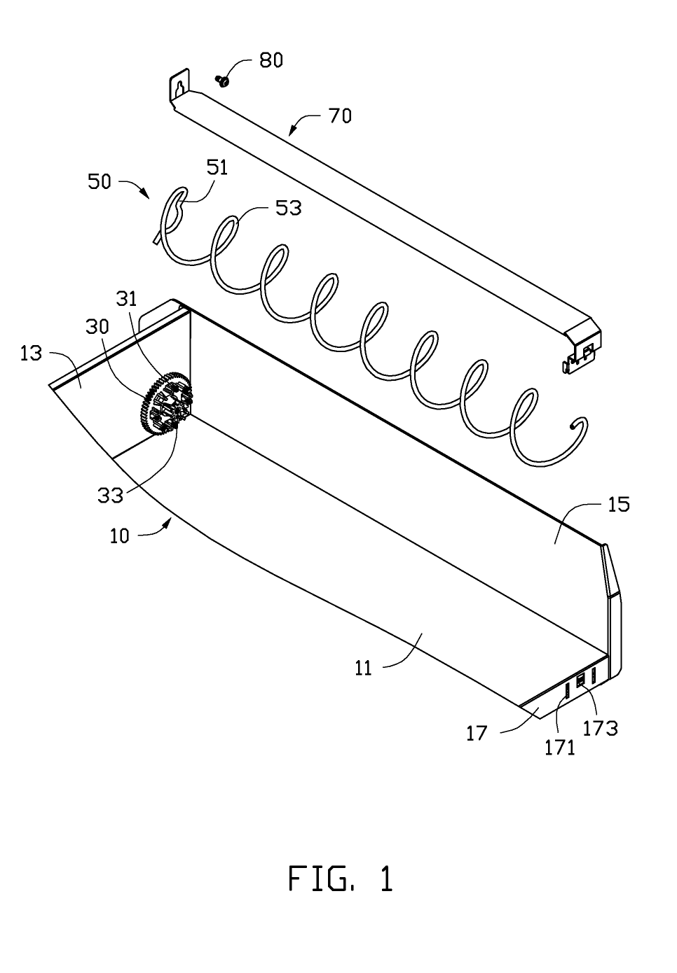

FIG. 1 shows a vending machine which includes a base 10, a securing member 30, a pushing member 50, and a loading member 70.

The base 10 includes a bottom panel 11, a first side panel 13, and a second side panel 15. The first side panel 13 and the second side panel 15 extend from the bottom panel and are substantially perpendicular to the bottom panel 11. The first side panel 13 is substantially perpendicular to the second side panel 15.

The bottom panel 11 includes a side wall 17, substantially parallel to the first side panel 13. The side wall 17 defines two securing slots 171 and a securing opening 173 located between the two securing slots 171. In one embodiment, the extending direction of the two securing slots 171 is substantially perpendicular to the bottom panel 11. The securing member 30 is mounted to the inner side of the first side panel 13. The securing member 30 defines a mounting slot 31 and a securing hole 33. The mounting slot 31 connects to the pushing member 50. The securing member 30 is connected to a motor (not shown), and rotates, driven by the motor, relative to the first side panel 13. The pushing member 50 includes a securing end 51 and a helical pushing portion 53, extending from the securing end 51. The goods are placed between the coils of the helical pushing portion 53 and are pushed to move out of the vending machine when the helical pushing portion 53 is rotated. The securing end 51 is secured to the mounting slot 31 of the securing member 30.

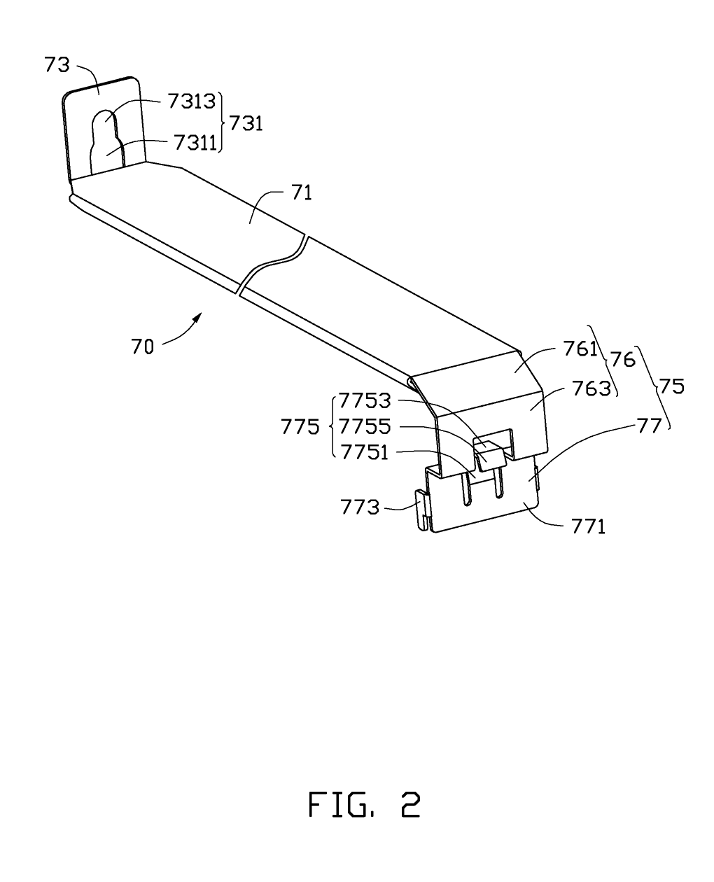

FIG. 2 shows that the loading member 70 includes a strip 71, substantially parallel to the bottom panel 11, a positioning tab 73, and a resilient securing structure 75. The positioning tab 73 and the resilient securing structure 75 extend from opposite sides of the strip 71.

The positioning tab 73 is substantially perpendicular to the strip 71. The positioning tab 73 defines a positioning slot 731. The positioning slot 731 defines a wide part 7311 and a narrow part 7313 communicating with the wide part 7311.

The resilient securing structure 75 includes a resilient portion 76 and a securing portion 77 connected to the resilient portion 76. The resilient portion 76 includes a connecting tab 761 slantingly extending from the strip 71 and an extending tab 763. The extending tab 763 is L-shaped. The securing portion 77 includes a securing tab 771 substantially parallel to the side wall 17, two hooks 773 extending from the securing tab 771, and an engaging portion 775 extending from the securing tab 771. The hook 773 is L-shaped. The engaging portion 775 includes a connecting arm 7751, an engaging tab 7753 that extends substantially perpendicularly from the connecting arm 7751, and a handle portion 7755 which slantingly extends from the engaging tab 7753.

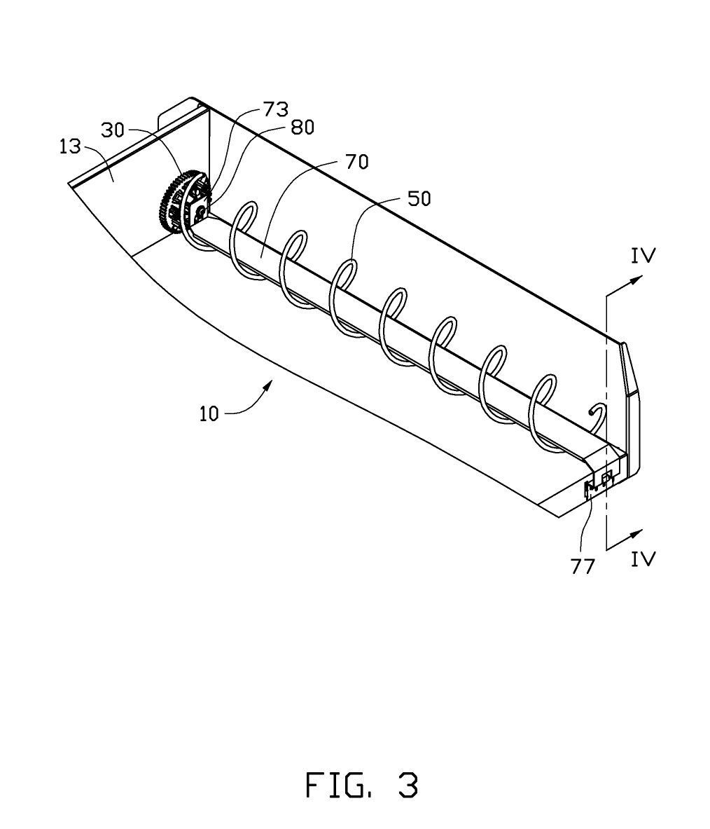

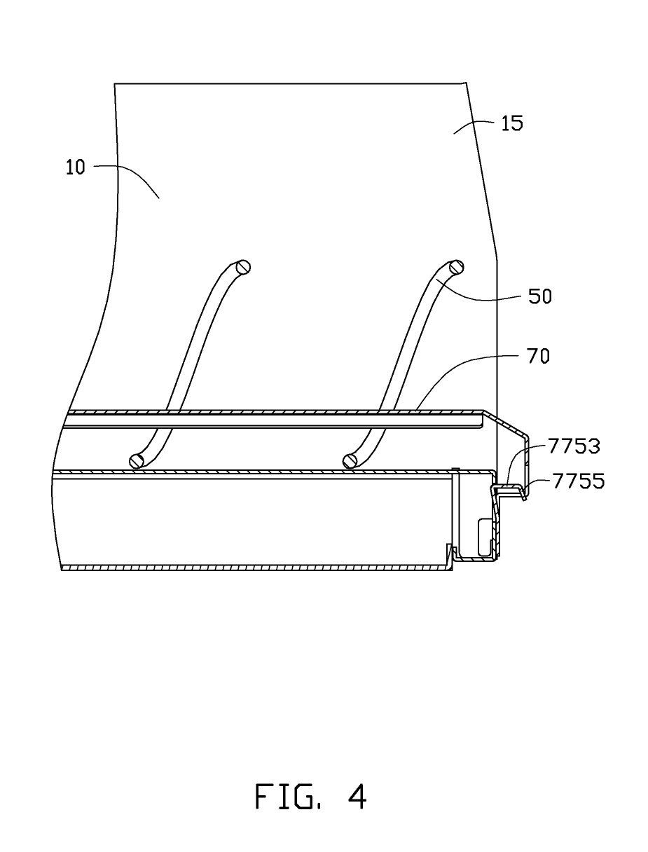

FIGS. 3 and 4 show that, in assembly, the securing end 51 of the pushing member 50 is secured to the mounting slot 31 of the securing member 30. A fastener 80 is secured into the securing hole 33. The loading member 70 moves in the base 10 and one end of the positioning tab 73 passes through the helical pushing portion 53 until the fastener 80 passes through the wide part 7311 of the positioning slot 731. The hooks 773 are inserted into the two securing slots 171 along a first direction that is substantially perpendicular to the bottom panel 11. The connecting arm 7751 of the engaging portion 775 resists the side wall 17. The loading member 70 moves downward until the engaging tab 7753 of the engaging portion 775 is aligned with the securing opening 173. The connecting arm 7751 rebounds to engage the engaging tab 7753 in the securing opening 173, thereby preventing the loading member 70 from moving along a second direction that is substantially opposite to the first direction. At this time, the fastener 80 engages in the narrow part 7313 of the positioning slot 731 and remains there by virtue of gravity.

In disassembly, the handle portion 7755 of the engaging portion 775 is pulled outward to disengage the engaging tab 7753 from the securing opening 173. The loading member moves upward. The narrow part 7313 moves up until the fastener 80 is in the wide part 7311. The loading member 70 can be moved far away from the first side panel 13, thereby moving out of the base 10.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A vending machine, comprising:
a base, the base comprises a bottom panel and a first side panel, extending from the bottom panel, and the bottom panel defines a securing opening;
a pushing member secured to the first side panel; and
a loading member, the loading member comprises a strip for supporting goods, a positioning tab extending from the strip, and a resilient securing structure; the positioning tab is placed on the first side panel; and the resilient securing structure comprises an engaging portion; the engaging portion comprises an engaging tab and a handle portion, extending from the engaging tab; the engaging tab engages in the securing opening; and the handle portion is configured to be operated to drive the engaging tab to disengage from the securing opening.

2. The vending machine of claim 1, wherein the resilient securing structure further comprises a resilient portion extending from the strip and a securing portion extending from the resilient portion; the securing portion comprises a securing tab; and the engaging portion further comprises a connecting arm connected between the securing tab and the engaging tab.

3. The vending machine of claim 2, wherein the securing portion further comprises a hook extending from the securing tab, and the bottom panel defines a securing slot engaging with the hook.

4. The vending machine of claim 3, wherein an extending direction of the securing slot is substantially perpendicular to the bottom panel.

5. The vending machine of claim 3, wherein the bottom panel comprises a side wall that is substantially parallel to the first side panel, and the securing opening and the securing slot are defined in the side wall.

6. The vending machine of claim 5, wherein the securing tab is substantially parallel to the side wall.

7. The vending machine of claim 5, wherein the first side panel is substantially parallel to the bottom panel.

8. The vending machine of claim 1, further comprising a securing member, wherein the securing member is secured to an inner side of the first side panel; the pushing member comprises a securing end secured to the securing member and a helical pushing portion extending from the securing end; and the strip is received in the helical pushing portion.

9. The vending machine of claim 8, wherein the positioning tab defines a positioning slot; the securing member defines a securing hole corresponding to the positioning slot; and a fastener is extended through to the positioning slot to be secured in the securing hole, thereby securing the positioning tab to the securing member.

10. The vending machine of claim 1, wherein the base further comprises a second side panel extending from the bottom panel; the second side panel is substantially perpendicular to the bottom panel; and the second side panel is substantially perpendicular to the first side panel.

11. A vending machine, comprising:
a base, the base comprise a bottom panel and a first side panel extending from the bottom panel, and the bottom panel defines a securing opening;
a securing member mounted to an inner side of the first side panel;
a pushing member, the pushing member comprises a securing end secured to the securing member and a helical pushing portion extending from the securing end, and the helical pushing portion is placed on the bottom panel; and
a loading member, the loading member comprises a strip received in the helical pushing portion, a positioning tab extending from the strip, and a resilient securing structure; the positioning tab is secured to the securing member; and the resilient securing structure engages in the securing opening.

12. The vending machine of claim 11, wherein the resilient securing structure comprises an engaging portion; the engaging portion comprises an engaging tab and a handle portion extending from the engaging tab; the engaging tab engages in the securing opening; and the handle portion is configured to be operated to drive the engaging tab to disengage from the securing opening.

13. The vending machine of claim 12, wherein the resilient securing structure further comprises a resilient portion extending from the strip and a securing portion extending from the resilient portion; the securing portion comprises a securing tab; and the engaging portion further comprises a connecting arm connected between the securing tab and the engaging tab.

14. The vending machine of claim 13, wherein the securing portion further comprises a hook extending from the securing tab, and the bottom panel defines a securing slot engaging with the hook.

15. The vending machine of claim 14, wherein an extending direction of the securing slot is substantially perpendicular to the bottom panel.

16. The vending machine of claim 14, wherein the bottom panel comprises a side wall that is substantially parallel to the first side panel, and the securing opening and the securing slot are defined in the side wall.

17. The vending machine of claim 16, wherein the securing tab is substantially parallel to the side wall.

18. The vending machine of claim 16, wherein the first side panel is substantially parallel to the bottom panel.

19. The vending machine of claim 11, wherein the positioning tab defines a positioning slot; the securing member defines a securing hole corresponding to the positioning slot;
and a fastener is extended through to the positioning slot to be secured in the securing hole, thereby securing the positioning tab to the securing member.

20. The vending machine of claim 11, wherein the base further comprises a second side panel extending from the bottom panel; the second side panel is substantially perpendicular to the bottom panel; and the second side panel is substantially perpendicular to the first side panel.
